(19) United States
(12) Patent Application Publication
(10) Pub. No.: US 2016/0148318 A1
(43) Pub. Date: May 26, 2016

(54) Policy System

(71) Applicant: Wage Lock LLC, Claremont, CA (US)

(72) Inventors: Patrick Moynihan, Santa Monica, CA (US); Jason Cardiff, Upland, CA (US)

(21) Appl. No.: 14/951,415

(22) Filed: Nov. 24, 2015

Related U.S. Application Data
(60) Provisional application No. 62/084,701, filed on Nov. 26, 2014.

(51) Int. Cl. G06Q 40/08; G06Q 10/10

(52) U.S. Cl. CPC G06Q 40/08; G06Q 10/1053

(57) ABSTRACT

A policy system may collect employment-related information and form a predictive model. In response to a request for a policy, the predictive model may determine an input for the policy. The predictive model may be automatically updated based on feedback received on the policy.

### CROSS-REFERENCE TO RELATED APPLICATIONS

The present application claims priority to provisional U.S. Patent Application Ser. No. 62/084,701, filed on Nov. 26, 2014, titled “Unemployment Protection Membership,” which is hereby incorporated by reference in its entirety.

### FIELD OF THE INVENTION

The present disclosure relates generally to the field of unemployment protection, and more specifically to systems and methods for determining a policy input based on an automatically adjustable predictive model.

### SUMMARY

Various embodiments of the present disclosure may be directed to a secure autonomous intelligent agent server performing a method. The method may comprise obtaining information over a network. A predictive model may be formed based on the information. A request for a policy may be received, and an input for the policy may be determined based on the predictive model. The policy may be issued, and policy feedback may be received. The predictive model may be automatically adjusted based on the policy feedback.

According to additional exemplary embodiments, the present disclosure may be directed to a secure autonomous intelligent agent server performing a method. The method may comprise obtaining employment-related information over a network. A request for a policy may be received. An algorithm may be formed based on the information to develop a baseline likelihood of continuing employment for one or more business sectors; track a change from the baseline likelihood based on new or updated information; and determine a risk of the policy being exercised based on the change from the baseline and the request. An input for the policy may be determined based on the risk, and the policy maybe issued. Policy feedback may be received. The change from the baseline likelihood may be automatically adjusted based on the policy feedback.

According to further exemplary embodiments, the present disclosure may be directed to a secure autonomous agent server performing a method. The method may comprise obtaining information over a network, and forming a predictive model based on the information. A request for a policy may be received. An initial input for the policy may be determined based on the predictive model. The policy may be issued, and policy feedback may be received. The predictive model may be automatically adjusted after a predetermined amount of time based on the policy feedback and new or updated information. A revised input may be determined based on the adjusted predictive model.

According to still further exemplary embodiments, the present disclosure may be directed to non-transitory computer readable media as executed by a system controller comprising a specialized chip to perform a method for maintaining a policy system. The method may comprise obtaining information over a network. A predictive model may be formed based on the information. A request for a policy may be received, and an input for the policy may be determined based on the predictive model. The policy may be issued, and policy feedback may be received. The predictive model may be automatically adjusted based on the policy feedback.

### BRIEF DESCRIPTION OF THE DRAWINGS

FIG. 1 is a flow diagram of an exemplary method for a policy system according to various embodiments.

FIG. 2 is flow diagram of an exemplary method for a policy system according to various embodiments.

FIG. 3 is a flow diagram of an exemplary method for a policy system according to various embodiments.

FIG. 4 is a flow diagram of an exemplary method for a policy system according to various embodiments.

FIG. 5 is a schematic diagram of a system architecture for a secure autonomous intelligent agent server according to various embodiments.

### DETAILED DESCRIPTION

It has been estimated that nearly 80 percent of American households have less than three months of expenses reserved in their savings accounts to pay bills should an unemployment situation arise. Given the current high rate of unemployment and low rate of economic growth, a job search may extend far beyond the economic means of most people, perhaps leading to devastating financial results. Government unemployment benefits only marginally affect this situation since these benefits represent only a fraction of net income, particularly for higher wage earners. Coupled with other major expenses that may occur during a period of unemployment, such as unexpected medical expenses and vehicle and home repairs, extended periods of unemployment have the potential to bankrupt many households, or leave them with a crippling amount of credit card debit.

Although the majority of people recognize that the threat of layoffs, reductions in force, and business closing is increasing, it is often difficult for them to quickly adjust their financial situation to where sufficient savings can be developed. Current consumer debt, housing expenses, and medical expenses must still be addressed each month. Some debt servicing companies, such as credit card companies, offer certain types of payment deferral or debt forgiveness programs but these programs are typically limited to the debt related to their company and offer nothing for other debts or expenses.

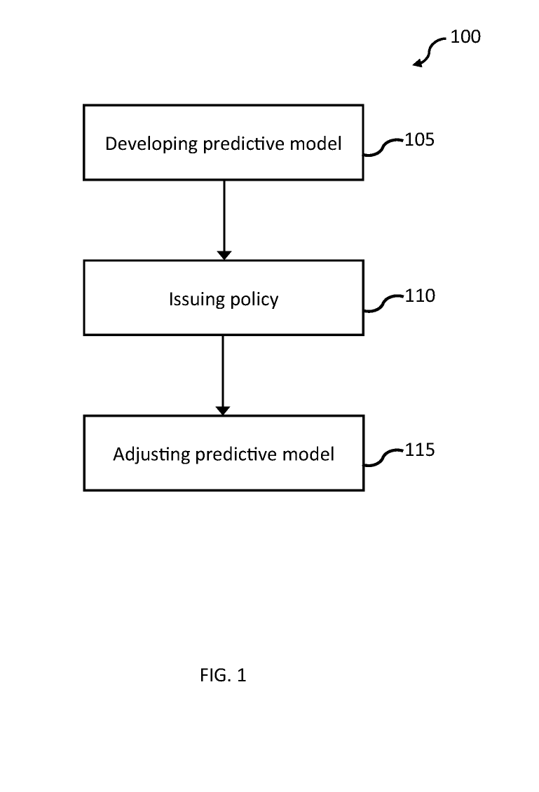

The present disclosure is directed to system and methods for a warranty system to protect the income of subscribers in the event of a loss of employment. In various embodiments as illustrated in FIG. 1, an exemplary method 100 may comprise development of a predictive model at step 105. The predictive model may comprise a variety of input data related to making a determination on employment stability. The determination may be directed to general employment conditions, such as the overall employment outlook for the United States. The determination may be limited to a certain future time period, such as the next month, quarter, year, or some other time period. The determination may be directed to certain geographic areas, such as a country, a region, a state, a city, or some other geographic area. For example, the determination may focus on the employment outlook in the southeastern United States, or may focus on North Carolina, or may focus still more narrowly on the city of Raleigh. Additionally, the determination may be directed to specific industries or industry sectors. For example, the determination may be directed to manufacturing industries, or may be directed to aerospace manufacturing, or may be more narrowly directed to aircraft manufacturing. In certain embodiments, for ease of classification and use of government census data, the determination may be made according to North American Industry Classification System (NAICS) codes. The determination may be made for a 2-digit NAICS code up to a 6-digit NAICS code. For example, the determination may be made for any of the following NAICS codes:

33—Manufacturing

336—Transportation Equipment Manufacturing

3364—Aerospace Products and Parts Manufacturing

33641—Aerospace Products and Parts Manufacturing

336411—Aircraft Manufacturing

The determination made by the predictive model in various embodiments may be directed to a combination of the factors described above (as well as other factors). For example, the determination may be made for an aircraft manufacturing facility under NAICS code 336411 located in Los Angeles, Calif. for the year 2016. Additionally, the determination may be directed to a trend over a period of time, such as the determination of employment stability for a certain industry over a five-year period.

Further, in various embodiments, the determination may also be directed to a specific employment position. In the previous example, the determination could be made for a Senior Mechanical Engineer with 20 years of experience at an aircraft manufacturing facility under NAICS code 336411 located in Los Angeles, Calif. for the year 2016. As will be evident to one skilled in the art, the determination may be directed to any one or any combination of factors related to economics, business, politics, trade, investment markets, demographics, and the like.

Returning to FIG. 1, at step 110 a first policy may be issued to a first subscriber based on the determination made by the predictive model in step 105. After the policy is issued, various factors may be monitored and data collected related to the performance of the first policy. The collected data may be used to adjust the predictive model at step 115. The method 100 may return to step 110 and a second policy may be issued to a second subscriber based on the adjusted predictive model. The second policy may vary from the first policy, for example, in a term of the policy, a maximum payout of the policy, a vesting period of the policy, a premium paid by the subscriber, or any other provision of the policy.

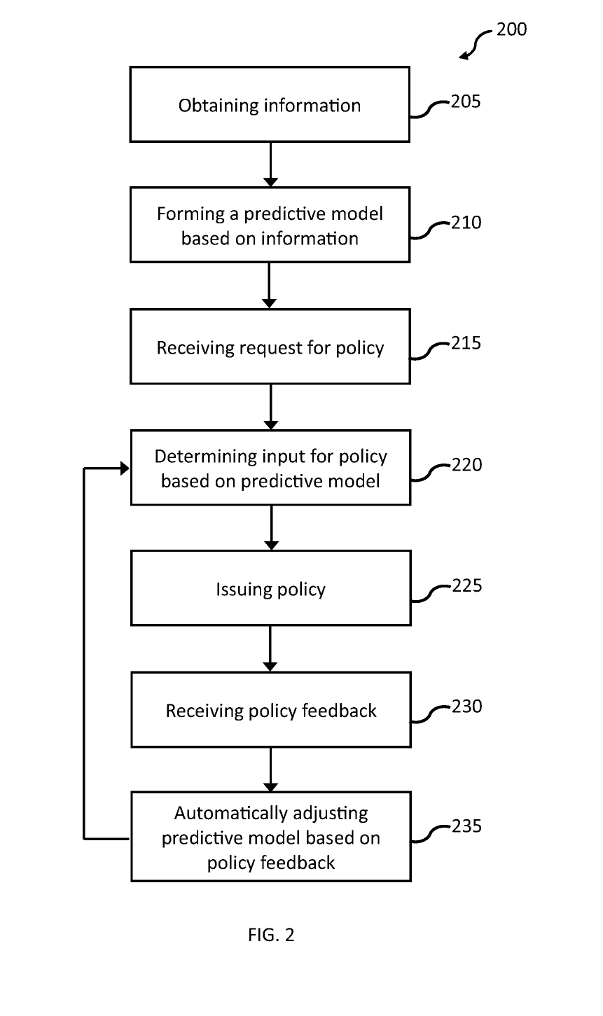

FIG. 2 illustrates a flow diagram of an exemplary method 200 for a warranty system to protect the income of subscribers in the event of a loss of employment according to various embodiments. At step 205, information is obtained which may form a basis for forming a predictive model (step 210). The information may comprise any data, trends, predictions, suppositions, estimates, and measurements—past, present or future—that may inform a determination of the likelihood of a given individual (subscriber) remaining employed for a given period of time (or conversely, the likelihood that the individual will become unemployed during the given period of time).

The information obtained at step 205 of method 200 may include government labor statistics, such as any of the data and information provided by the Bureau of

Labor Statistics of the United Stated Department of Labor. These data and information may comprise, but are not limited to, inflation and price data such as the Consumer Price Index, various producer price indexes, import/export price indexes, employment cost indexes, and contract escalation; pay and benefits data such as employment costs, national compensation data, wages compiled by area and occupation, earnings by demographics, earnings by industry, county wages, benefits, and strikes and lockouts; spending and time use data such as consumer expenditures and how time is spent; unemployment data such as national unemployment rate, state and local unemployment rates, and layoffs; employment data such as national employment, state and local employment, state and county employment, worker characteristics, employment projections, job openings and labor turnover, green goods and services, green goods and services occupations, green technologies and practices, employment by occupation, work experience over time, and business employment dynamics; productivity data such as labor productivity and costs, and multifactor productivity; international data such as international labor comparisons and international technical cooperation.

The information obtained at step 205 may also comprise government census statistics such as that provided by the United States Census Bureau of the United Stated Department of Commerce. The census data may comprise, but are not limited to population and housing data such as annual population estimates, demographic and housing estimates, general housing characteristics, and general demographic characteristics; poverty and income data such as general economic characteristics; age, race, sex and education data such as social characteristics and education attainment; business and industry data such as nonemployer statistics, ZIP code business patterns, county business patterns, economic surveys, census of manufacturers, and minority- and women-owned business reports; geographic census data; foreign trade data such as U.S. imports and exports of merchandise; census of governments; housing data such as residential financial survey, property owners and managers survey, and American housing survey data; people and households data such as county population estimates, survey of income and program participation, and current population survey.

Additionally, the information obtained at step 205 may comprise the current Federal Reserve Federal Funds Rate and U.S. Treasury Bond Rate, as well as projections of changes to the rates depending on any economic, business, political, or natural phenomena events. The information may further comprise employer and corporate information, either in general terms or consolidated according to specific industries or geographic areas, as well as industry sales data and projections. The information may also comprise data on various markets such as stock and options market data and projections, commodity market data and projections, mutual fund data and projections, precious metals market data and projections, world market data and projections, and energy market data and projections.

The information obtained at step 205 may also comprise such data as bankruptcy court filings, domestic and foreign political stability, government election data and projections, venture capital data and projections, weather forecasting data, and environmental health risk data and projections.

Returning to FIG. 2, at step 210 a predictive model may be formed based on the information obtained at step 205. The predictive model may use any portion of the information obtained at step 205 to make a determination on employment stability. That is, the predictive model may determine as described previously the likelihood of a given individual (subscriber) remaining employed for a given period of time (or conversely, the likelihood that the individual will become unemployed during the given period of time and exercise the policy). The predictive model may use statistical analyses, regression analyses, or any other predictive analytics, alone or in combination, to create a model of future employment events. The predictive model may also use machine learning techniques and protocols in further development and refinement of the model. Additionally, the predictive model may be a parametric model, a non-parametric model, or a semi-parametric model. The predictive model may use any combination of computation techniques and algorithms such as group method of data handling, naive Bayes classifiers, k-nearest neighbor algorithms, majority classifiers, support vector machines, random forest machine learning techniques, gradient boosting machine learning techniques, multivariate adaptive regression splines, artificial neural networks, least squares methods, generalized linear models, logistic regression techniques, robust regression techniques, semiparametric regression techniques, generalized additive models, and the like.

At step 215, a request for a policy may be received from a potential subscriber. The request may be received over a network and may comprise data and information related to the potential subscriber, such as but not limited to name, age, address, marital status, gender, race, ethnicity, number and age of children, social security number, bank account information, name of employer, address of employer, salary, length of employment, job title, NAICS code for the employer, past employment history, credit score, credit bureau ratings, mortgage information, and income tax filing information.

In various embodiments, forming the predictive model may comprise compiling the information obtained at step 205, then determining which of the information may be relevant information based on the request. For example, if the employer information provided in the request indicates that the employer is a software service provider, then the predictive model may determine that labor statistics for service industries is relevant information (as opposed to labor statistics for manufacturing industries which may not be deemed relevant information). The predictive model may then determine the likelihood of the policy being exercised based only on the relevant information and the request.

The predictive model may determine an input for the policy at step 220 based on any portion of the information obtained at step 205 and the subscriber information received with the request at step 215. In various embodiments, the input may comprise compensation for undertaking a risk that the policy is exercised. The compensation may be a one-time or a recurring premium that the subscriber must pay to maintain the policy in force. If the predictive model determines that the employment stability of the subscriber is within an acceptable range, and the subscriber provides the input determined at step 220, the policy may be issued to the subscriber at step 225. In various embodiments, the issuing may comprise electronically transmitting information to the subscriber comprising a term for the policy, a holder of the policy, exclusions of the policy, exemptions to the policy, limitations of the policy, rights and responsibilities of the policy holder, a policy premium, definition of policy terms, and endorsements.

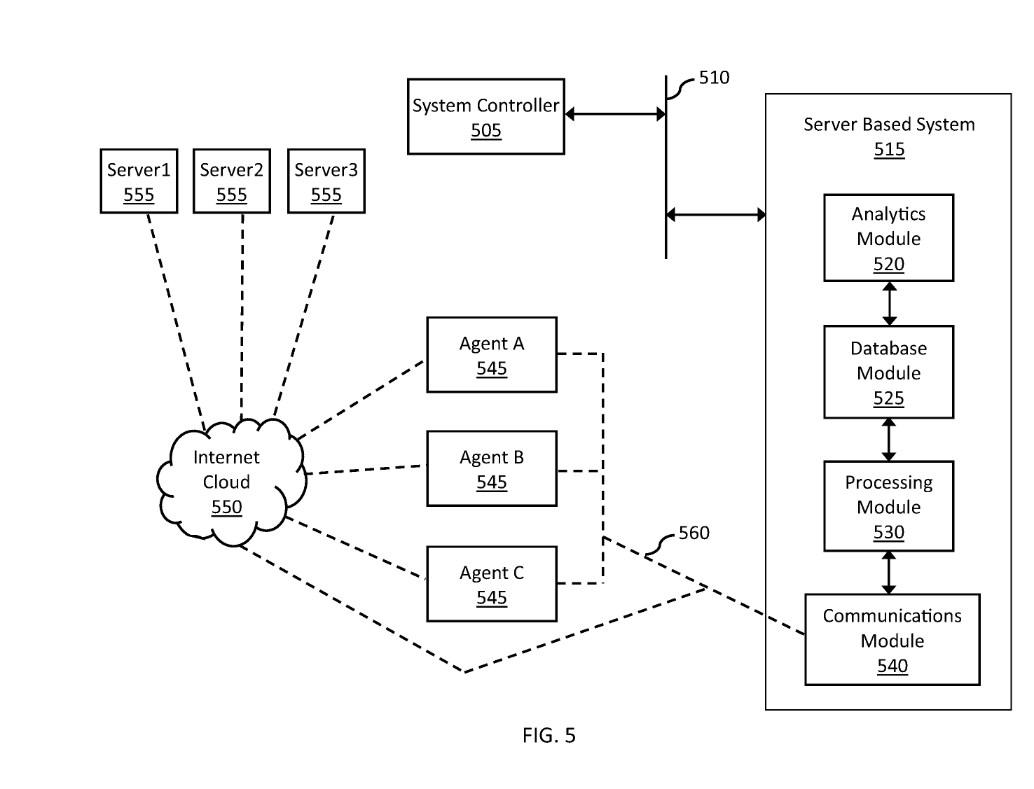

After issuance of the policy at step 225, policy feedback may be received at step 230. The policy feedback may comprise information related to the administration of the policy issued to the subscriber, and in certain embodiments other subscribers. The feedback may comprise verification of information contained in the request, verification of continued employment, payment of policy premiums, a request to exercise the policy, a change in employer, a change in any portion of the request, and a change in salary. At step 235, the predictive model may be automatically adjusted based on the policy feedback received at step 230. In certain embodiments, the automatic adjustment of the predictive model at step 235 may also be based, or may alternatively be based, on new or updated information for that received at step 205. Automatically adjusting the predictive model may comprise modifying an output of an algorithm of the predictive model as influenced by the policy feedback. The method 200 may return to step 220 and determine another input for the next potential subscriber based on the adjusted predictive model. As described further below in relation to FIG. 5, the method 200 may be performed by a secure autonomous agent server, and the autonomous agent server may automatically adjust the predictive model at step 235.

In various embodiments, the method 100 may further comprise security features comprising any of encryption, firewalls, policy holder identity verification, virtual private networks, user account controls, authorization manager, network access controls, virus protection, spyware protection, malware protection, phishing protection, spam protection, behavior monitoring, attachment filtering, content filtering, and web filtering.

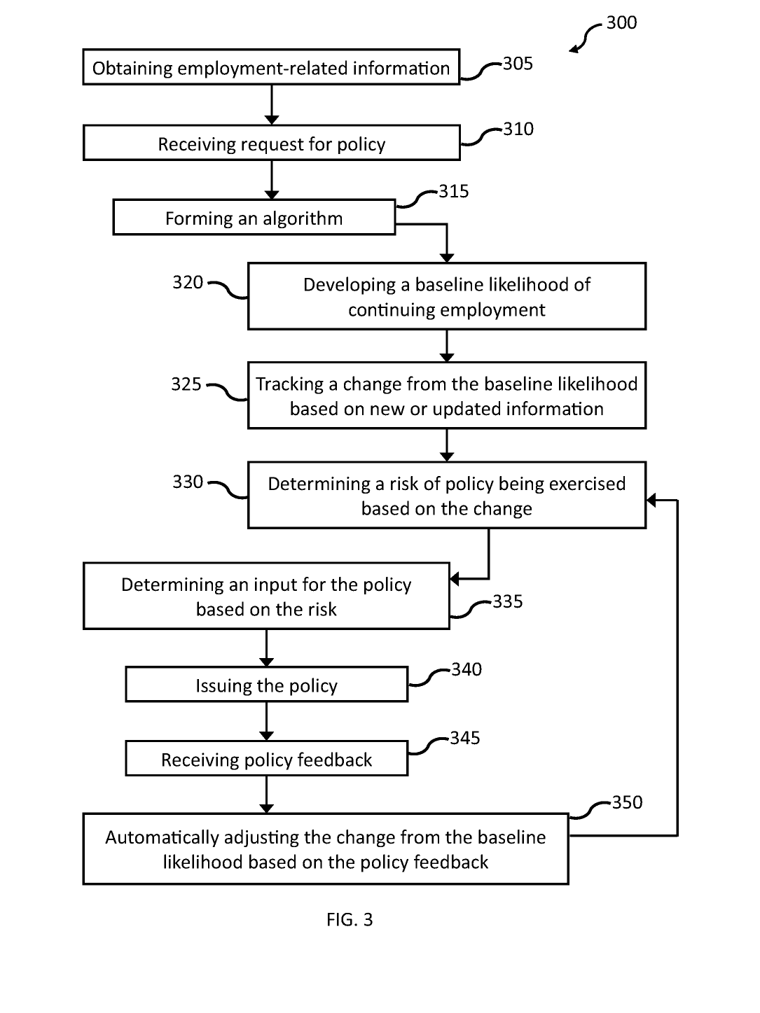

FIG. 3 illustrates a flow diagram of an exemplary method 300 for a warranty system to protect the income of subscribers in the event of a loss of employment according to various embodiments. At step 305, employment-related information may be obtained over a network. In various embodiments, the employment-related information may encompass the information described previously for step 205 of method 200 of FIG. 2. At step 310, a request for a policy may be received from a potential subscriber, and may comprise data and information related to the potential subscriber as described above for step 215 of method 200 of FIG. 2. At step 315, an algorithm may be formed. The algorithm may use any portion of the information obtained at steps 305 and 310 to make a determination on employment stability. That is, the algorithm may determine as described previously the likelihood of a given individual (subscriber) remaining employed for a given period of time (or conversely, the likelihood that the individual will become unemployed during the given period of time and exercise the policy). The algorithm may use statistical analyses, regression analyses, or any other predictive analytics, alone or in combination, to create a model of future employment events. The algorithm may also use machine learning techniques and protocols in further development and refinement of the model. Additionally, the algorithm may be a parametric model, a non-parametric model, or a semi-parametric model. The predictive model may use any combination of computation techniques and algorithms such as group method of data handling, naive Bayes classifiers, k-nearest neighbor algorithms, majority classifiers, support vector machines, random forest machine learning techniques, gradient boosting machine learning techniques, multivariate adaptive regression splines, artificial neural networks, least squares methods, generalized linear models, logistic regression techniques, robust regression techniques, semiparametric regression techniques, generalized additive models, and the like.

At step 320, a baseline likelihood of continuing employment for one or more business sectors or industries may be developed. The baseline may be specific to the potential subscriber or a group of potential and/or existing subscribers, or may apply generally to an industry, an industry sector, a geographic area, or any other division of interest. Periodically, new or updated information obtained in step 305 may be obtained, and the algorithm may redetermine the baseline likelihood based on the new or updated information at step 325. The algorithm may track a change from the baseline likelihood to the redetermined baseline likelihood, and determine at step 330 a risk of the policy being exercised based on the tracked change. For example, the original baseline may have shown a 90 percent likelihood of continued employment over the next year for a potential subscriber, resulting in a low risk value at step 330. However, after new or updated information included extensive layoff data in multiple geographic areas of the country for the potential subscriber's industry sector, the baseline may change to a 50 percent likelihood, thereby increasing the risk determined at step 330.

Continuing now with FIG. 3, an input for the policy may be determined at step 335 based on the risk determined at step 330 using the new or updated information. As described previously, the input may comprise compensation for undertaking a risk that the policy is exercised. The compensation may be a one-time or a recurring premium that the subscriber must pay to maintain the policy in force. If the predictive model determines that the employment stability of the subscriber is within an acceptable range, and the subscriber provides the input determined at step 335, the policy may be issued to the subscriber at step 340. In various embodiments, the issuing may comprise electronically transmitting information to the subscriber comprising a term for the policy, a holder of the policy, exclusions of the policy, exemptions to the policy, limitations of the policy, rights and responsibilities of the policy holder, a policy premium, definition of policy terms, and endorsements.

At step 345, policy feedback may be received as described previously for step 230 of method 200 of FIG. 2. The change from the baseline likelihood may be automatically adjusted at step 350 based on the policy feedback received at step 345. The method 300 may return to step 330, wherein the risk of the policy being exercised may be redetermined for subsequent potential subscribers based on the automatically adjusted change from the baseline likelihood from step 350.

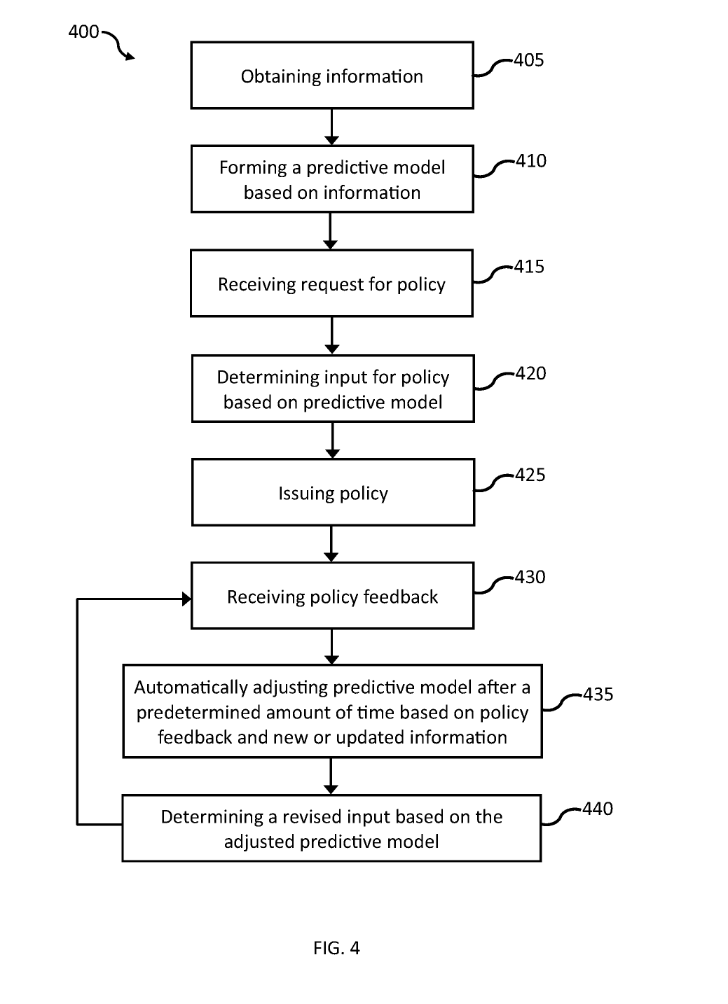

FIG. 4 illustrates a flow diagram of an exemplary method 400 for a warranty system to protect the income of subscribers in the event of a loss of employment according to various embodiments. Steps 405 through 430 are as described above for steps 205 through 230, respectively, for method 200 of FIG. 2. At step 435, the predictive model may be automatically adjusted as described previously using policy feedback information. In addition, the information obtained at step 405 may be updated or new information obtained, and the predictive model may be automatically updated based on this new or updated information. The new or updated information may be obtained after a predetermined amount of time, such as weekly, monthly, quarterly, semiannually, annually, or any other desired period of time. At step 440, a revised input based on the adjusted predictive model may be determined. According to the various embodiments of method 400, the premium paid by the subscriber may change from time to time (as opposed to being fixed at the level established at step 420) to account for the changing likelihood of continuing employment and, thus, the changing risk of the policy being exercised.

FIG. 5 illustrates a schematic diagram of a system architecture for a secure autonomous intelligent agent server capable of implementing the methods of the present disclosure. A system controller 505 may be coupled to a server based system 515 by a bus 510, or any other connection device known in the art. The system controller 505 may comprise a specialized chip capable of executing non-transitory computer readable media to perform one or more of the methods 100, 200, 300, 400.

The server based system 515 may comprise executable instruction contained at least partially on the non-transitory computer readable media. A database module 525 may be configured to receive information, as well as new and updated information, store and organize the information, and retrieve the information. The information stored in the database module 525 may comprise any data, trends, predictions, suppositions, estimates, and measurements—past, present or future—that may inform a determination of the likelihood of a given individual (subscriber) remaining employed for a given period of time. The database module 525 may comprise a relational database such that relationships between the data are maintained.

A processing module 530 may also be present within the server based system 515 that is communicatively coupled to the database module 525. The processing module 530 may execute requests to enter data, retrieve data, analyze data, and handle other operational requests.

Additionally, the server based system 515 may further comprise a communications module 540 communicatively coupled to the processing module 530. The communications module may also be communicatively coupled to a plurality of agents 545, which may be intelligent agents 545, as well as communicatively coupled to the Internet such as through a cloud-based computing environment 550.

The server based system 515 may also comprise an analytics module 520 communicatively coupled to the database module 525. The analytics module may contain and/or process the predictive model and the algorithms. Processing the predictive model and algorithms may involve the information stored in the database module 525.

The agents 545 may be communicatively coupled to one or more servers 555 external to the server based system 515. The servers may contain the information obtained as described above for methods 100, 200, 300 and 400. The agents 545 may acquire the desired information from the servers 555 and transfer the information to the database module 525 via the communications module 540 and the processing module 530. The agents 545 may acquire the information by executing queries, scraping a network, crawling a network, data mining, data aggregation, or any other data acquisition techniques or methods known in the art.

The system controller 505 may be communicatively coupled to the communications module 540, through which the system controller 505 may communicate via a network 560 with one or more intelligent agents 545 and/or the external servers 555. The network 560 can be a cellular network, the Internet, an Intranet, or other suitable communications network, and can be capable of supporting communication in accordance with any one or more of a number of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth, Wireless LAN (WLAN) protocols/techniques.

The intelligent agent 545, according to some exemplary embodiments, may be a non-generic computing device comprising non-generic computing components. The intelligent agent 545 may comprise dedicated hardware processors to determine, transmit, and receive video and non-video data elements. In further exemplary embodiments, the intelligent agent 545 may comprise a specialized device having circuitry and specialized hardware processors, and is artificially intelligent, including machine learning. Numerous determination steps by the intelligent agent 545 as described herein can be made to video and non-video data by an automatic machine determination without human involvement, including being based on a previous outcome or feedback (e.g., automatic feedback loop) provided by the networked architecture, processing and/or execution as described herein.

According to various embodiments, the system controller 505 may communicate with a cloud-based computing environment 550, 555 that collects, processes, analyzes, and publishes datasets. In general, a cloud-based computing environment 550, 555 may be a resource that typically combines the computational power of a large grouping of processors and/or that combines the storage capacity of a large group of computer memories or storage devices. For example, systems that provide a cloud resource can be utilized exclusively by their owners, such as Google™ or Amazon™, or such systems can be accessible to outside users who deploy applications within the computing infrastructure to obtain the benefits of large computational or storage resources.

The cloud 550 can be formed, for example, by a network of web servers with each server (or at least a plurality thereof) providing processor and/or storage resources. These servers can manage workloads provided by multiple users (e.g., cloud resource customers or other users). Typically, each user places workload demands upon the cloud 550 that vary in real-time, sometimes dramatically. The nature and extent of these variations typically depend upon the type of business associated with each user.

Some of the above-described functions can be composed of instructions that are stored on storage media (e.g., computer-readable media). The instructions can be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable medium” and “computer-readable media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic media, a CD-ROM disk, digital video disk (DVD), any other optical media, any other physical media with patterns of marks or holes, a RAM, a PROM, an EPROM, an EEPROM, a FLASHEPROM, any other memory chip or data exchange adapter, a carrier wave, or any other media from which a computer can read.

Various forms of computer-readable media can be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

While the present disclosure has been described in connection with a series of preferred embodiments, these descriptions are not intended to limit the scope of the disclosure to the particular forms set forth herein. The above description is illustrative and not restrictive. Many variations of the embodiments will become apparent to those of skill in the art upon review of this disclosure. The scope of this disclosure should, therefore, be determined not with reference to the above description, but instead should be determined with reference to the appended claims along with their full scope of equivalents. The present descriptions are intended to cover such alternatives, modifications, and equivalents as can be included within the spirit and scope of the disclosure as defined by the appended claims and otherwise appreciated by one of ordinary skill in the art. In several respects, embodiments of the present disclosure can act to close the loopholes in the current industry practices in which good business practices and logic are lacking because it is not feasible to implement with current resources and tools.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

What is claimed is:

1. A secure autonomous intelligent agent server performing a method comprising:
obtaining information over a network;
forming a predictive model based on the information;
receiving a request for a policy;
determining an input for the policy based on the predictive model;
issuing the policy;
receiving policy feedback; and
automatically adjusting the predictive model based on the policy feedback.

2. The method of claim 1 wherein the information comprises any of government labor statistics, government census statistics, Federal Reserve Federal Funds Rate and projections, U.S. Treasury Bond data and projections, employer information, corporate information, industry sales data and projections, stock and options market data and projections, commodity market data and projections, currency market data and projections, mutual fund data and projections, precious metals market data and projections, world market data and projections, energy market data and projections, bankruptcy court filings, domestic and foreign political stability, government election data and projections, venture capital data and projections, weather forecasting data, and environmental health risk data and projections.

3. The method of claim 1 wherein the predictive model predicts a likelihood of the policy being exercised.

4. The method of claim 1 wherein the request is received over the network and comprises any of name, address, marital status, gender, race, ethnicity, number and age of children, social security number, bank account information, name of employer, address of employer, salary, length of employment, job title, North American Industry Classification System code for employer, past employment history, credit score, credit bureau ratings, mortgage information, and income tax filing information.

5. The method of claim 1 wherein the input comprises compensation for undertaking a risk that the policy is exercised.

6. The method of claim 1, wherein the issuing comprises electronically transmitting information comprising a term for the policy, a holder of the policy, exclusions of the policy, exemptions to the policy, limitations of the policy, rights and responsibilities of the policy holder, a policy premium, definitions of policy terms, and endorsements.

7. The method of claim 1 wherein the policy feedback comprises any of verification of information contained in the request, verification of continued employment, payment of policy premiums, a request to exercise the policy, a change in employer, a change in any portion of the request, and a change in salary.

8. The method of claim 1, wherein forming a predictive model comprises developing an algorithm to:
compile the information;
determine relevant information based on the request;
determine a likelihood of the policy being exercised based on the relevant information and the request.

9. The method of claim 8, wherein the algorithm further comprises:
developing a baseline likelihood;
tracking a change from the baseline likelihood based on new or updated information;
adjusting the input based on the change from the baseline.

10. The method of claim 1 wherein automatically adjusting the predictive model comprises modifying an algorithm's output as influenced by the policy feedback.

11. The method of claim 1, further comprising security features comprising any of encryption, firewalls, policy holder identity verification, virtual private networks, user account controls, authorization manager, network access controls, virus protection, spyware protection, malware protection, phishing protection, spam protection, behavior monitoring, attachment filtering, content filtering, and web filtering.

12. The method of claim 1, wherein obtaining information over the network comprises deploying agents.

13. A secure autonomous intelligent agent server performing a method comprising:
obtaining employment-related information over a network;
receiving a request for a policy;
forming an algorithm based on the information to:
develop a baseline likelihood of continuing employment for one or more business sectors;
track a change from the baseline likelihood based on new or updated information;
determine a risk of the policy being exercised based on the change from the baseline and the request;
determining an input for the policy based on the risk;
issuing the policy;
receiving policy feedback;
automatically adjusting the change from the baseline likelihood based on the policy feedback.

14. The method of claim 13 wherein the employment-related information comprises any of government labor statistics, government census statistics, Federal Reserve Federal Funds Rate and projections, U.S. Treasury Bond data and projections, employer information, corporate information, industry sales data and projections, stock and options market data and projections, commodity market data and projections, currency market data and projections, mutual fund data and projections, precious metals market data and projections, world market data and projections, energy market data and projections, bankruptcy court filings, domestic and foreign political stability, government election data and projections, venture capital data and projections, weather forecasting data, and environmental health risk data and projections.

15. The method of claim 13 wherein the request is received over the network and comprises any of name, address, marital status, gender, race, ethnicity, number and age of children, social security number, bank account information, name of employer, address of employer, salary, length of employment, job title, North American Industry Classification System code for employer, past employment history, credit score, credit bureau ratings, mortgage information, and income tax filing information.

16. The method of claim 13 wherein the input comprises compensation for undertaking the risk that the policy is exercised.

17. The method of claim 13, wherein the issuing comprises electronically transmitting information comprising a term for the policy, a holder of the policy, exclusions of the policy, exemptions to the policy, limitations of the policy, rights and responsibilities of the policy holder, a policy premium, definitions of policy terms, and endorsements.

18. The method of claim 13 wherein the policy feedback comprises any of verification of information contained in the request, verification of continued employment, payment of policy premiums, a request to exercise the policy, a change in employer, a change in any portion of the request, and a change in salary.

19. A secure autonomous intelligent agent server performing a method comprising:
obtaining information over a network;
forming a predictive model based on the information;
receiving a request for a policy;
determining an initial input for the policy based on the predictive model;
issuing the policy;
receiving policy feedback;
automatically adjusting the predictive model after a predetermined amount of time based on the policy feedback and new or updated information;
determining a revised input based on the adjusted predictive model.

20. The method of claim 19, wherein the predetermined amount of time comprises any of weekly, monthly, quarterly, semiannually, and annually.

21. The method of claim 19 wherein the employment-related information comprises any of government labor statistics, government census statistics, Federal Reserve Federal Funds Rate and projections, U.S. Treasury Bond data and projections, employer information, corporate information, industry sales data and projections, stock and options market data and projections, commodity market data and projections, currency market data and projections, mutual fund data and projections, precious metals market data and projections, world market data and projections, energy market data and projections, bankruptcy court filings, domestic and foreign political stability, government election data and projections, venture capital data and projections, weather forecasting data, and environmental health risk data and projections.

22. The method of claim 19 wherein the request is received over the network and comprises any of name, address, marital status, gender, race, ethnicity, number and age of children, social security number, bank account information, name of employer, address of employer, salary, length of employment, job title, North American Industry Classification System code for employer, past employment history, credit score, credit bureau ratings, mortgage information, and income tax filing information.

23. The method of claim 19 wherein the initial and revised inputs comprise compensation for undertaking the risk that the policy is exercised.

24. The method of claim 19, wherein the issuing comprises electronically transmitting information comprising a term for the policy, a holder of the policy, exclusions of the policy, exemptions to the policy, limitations of the policy, rights and responsibilities of the policy holder, a policy premium, definitions of policy terms, and endorsements.

25. The method of claim 13 wherein the policy feedback comprises any of verification of information contained in the request, verification of continued employment, payment policy premiums, a request to exercise the policy, a change in employer, a change in any portion of the request, and a change in salary.

26. Non-transitory computer readable media as executed by a system controller comprising a specialized chip to perform a method for a policy system, the method comprising:
obtaining information over a network;
forming a predictive model based on the information;
receiving a request for a policy;
determining an input for the policy based in on the predictive model;
issuing the policy;
receiving policy feedback; and
automatically adjusting the predictive model based on the policy feedback.

27. The non-transitory computer readable media of claim 26, wherein the employment-related information comprises any of government labor statistics, government census statistics, Federal Reserve Federal Funds Rate and projections, U.S. Treasury Bond data and projections, employer information, corporate information, industry sales data and projections, stock and options market data and projections, commodity market data and projections, currency market data and projections, mutual fund data and projections, precious metals market data and projections, world market data and projections, energy market data and projections, bankruptcy court filings, domestic and foreign political stability, government election data and projections, venture capital data and projections, weather forecasting data, and environmental health risk data and projections.

28. The non-transitory computer readable media of claim 26, wherein the request is received over the network and comprises any of name, address, marital status, gender, race, ethnicity, number and age of children, social security number, bank account information, name of employer, address of employer, salary, length of employment, job title, North American Industry Classification System code for employer, past employment history, credit score, credit bureau ratings, mortgage information, and income tax filing information.

29. The non-transitory computer readable media of claim 26, wherein the issuing comprises electronically transmitting information comprising a term for the policy, a holder of the policy, exclusions of the policy, exemptions to the policy, limitations of the policy, rights and responsibilities of the policy holder, a policy premium, definitions of policy terms, and endorsements.

30. The non-transitory computer readable media of claim 26, wherein the policy feedback comprises any of verification of information contained in the request, verification of continued employment, payment policy premiums, a request to exercise the policy, a change in employer, a change in any portion of the request, and a change in salary.
